(19) United States
(12) Patent Application Publication
(10) Pub. No.: US 2012/0240026 A1
(43) Pub. Date: Sep. 20, 2012

(54) METHOD AND SYSTEM FOR RELATED ART CITATION MANAGEMENT

(75) Inventors: Priya Iyer, Wellesley, MA (US); Kelly Crawford, Sundance, WY (US); David Bartle, Acton, MA (US); Damian Porcari, Farmington Hills, MI (US); Erik Bailey, Needham, MA (US)

(73) Assignee: ANAQUA, INC., Boston, MA (US)

(21) Appl. No.: 13/418,104

(22) Filed: Mar. 12, 2012

Related U.S. Application Data
(60) Provisional application No. 61/476,567, filed on Apr. 18, 2011.
(60) Provisional application No. 61/452,382, filed on Mar. 14, 2011.

(51) Int. Cl. G06F 17/00

(52) U.S. Cl. 715/231

(57) ABSTRACT

Example embodiments relate to related art citation management. One example embodiment includes a method of automating related art citation generation. The method includes reading a citation status of a related art reference for a patent document. The method further includes generating a related art reference list document. Additionally, in response to the citation status of the related art reference having a first citation status value, the method includes inserting into the related art reference list document a related art citation, the related art citation comprising metadata for the related art reference.

### CROSS-REFERENCE TO RELATED APPLICATIONS

This application claims the benefit of and priority to U.S. Provisional Application No. 61/476,567, filed on Apr. 18, 2011 and U.S. Provisional Application No. 61/452,382, filed on Mar. 14, 2011 which are incorporated herein by reference.

### TECHNICAL FIELD

Embodiments relate generally to intellectual asset docketing and management. More particularly, some example embodiments relate to related art citation management.

### BACKGROUND

A docketing system is utilized to schedule legal matters and manage aspects of intellectual property (IP) assets, where IP assets include, for example: patents, trade secrets, publications, trademarks, domain names, and copyrights. A patent management system, which may be part of an overall intellectual asset management (IAM) solution, may support docketing and potentially other related activities in the full lifecycle of patent assets, such as invention disclosure submission, multi-party collaboration, document and e-mail management, configurable business workflow rules, and business intelligence tools, among other features. A patent management system provides visibility and access to internal and external participants in the patent asset management process—for example, attorneys, agents and paralegals, researchers and engineers, portfolio managers, marketing, licensing professionals and other business managers.

challenge facing users of patent docketing and management systems is properly disclosing to a patent office any prior art or background information that may be relevant to the patentability of an invention in a patent application. Patent applicants and their corresponding patent practitioners often find it difficult to keep track of what related art has been cited for other patent applications within the same patent family, either by the applicant, the practitioner, or the patent office. Many countries, including the United States, require disclosure of potentially relevant art. For example, according to United States Code Title 35 and related sections of 37 CFR and the Manual of Patent Examining Procedure (MPEP), there is a duty on all patent applicants, their practitioners, and legal staff to disclose prior art or background information that may be relevant to patentability. An information disclosure statement (IDS) is a submission of relevant background art or information to the United States Patent and Trademark Office (USPTO) by a patent applicant during the patent prosecution process. If a patent applicant is found to have knowingly or intentionally withheld prior art from the USPTO, then any patent that later issues from the patent application may be declared unenforceable. Because patent family members in other jurisdictions are often managed by different patent practitioners, central coordination and cross-referencing can be a time-consuming and error-prone process.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

Embodiments relate generally to intellectual asset docketing and management. More particularly, some example embodiments relate to related art citation management.

In one example embodiment, a method of automating related art citation generation is provided, wherein the method comprises reading a citation status of a related art reference for a patent document; generating a related art reference list document; and in response to the citation status of the related art reference having a first citation status value, inserting into the related art reference list document a related art citation, the related art citation comprising metadata for the related art reference. Additionally, the method may further comprise modifying the citation status to have a second citation status value after inserting the related art citation into the related art reference list document. The first citation status value denotes a need to cite the related art reference, and the second citation status value denotes citation of the related art reference. The method may further comprise detecting a user input, the user input triggering generation of the related art reference list document. Prior to generating the related art reference list document, a preview of the related art reference list document may be generated, wherein generating the preview preserves the first citation status value of the citation status.

In another example embodiment, a method of maintaining a citation status of a related art reference for a first patent document in a patent family is provided, the method comprising adding the related art reference to a first record in a patent docketing system; and setting the citation status to a first citation status value in response to adding the related art reference to the first record, wherein the first record pertains to one of the first patent document and a second patent document in the patent family. The method may further comprise determining a source of the related art reference and setting the citation status based upon, among other attributes, the source of the related art reference.

In an example embodiment, a docketing server comprising at least one memory device for storing one or more intellectual asset records and a controller operatively connected to the at least one memory device is provided. The docketing server controller presents a citation matrix for a first patent document in a patent family, wherein the citation matrix is presented as a table, the table comprising at least one row and at least one column. The controller further populates the table with at least one patent document identifier and at least one related art reference identifier, wherein at least one patent document identifier comprises an identifier of the first patent document; and the docketing server controller also displays a citation status for each combination of a patent document identifier of the at least one patent document identifier and a related art reference identifier of the at least one related art reference identifier, wherein the combination is denoted as an intersection of a row of the at least one row and a column of the at least one column. In another embodiment the at least one patent document identifier further comprises an identifier of a second patent document, wherein the second patent document is also a member of the patent family. The docketing server controller may also provide to a user of the docketing server an ability to input the citation status, with possible citation status values comprising one of “not yet considered”, “to be cited”, “cited”, “do not cite”, and “undecided” according to the user input.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Additional features and advantages of the invention will be set forth in the description, which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only embodiments of the invention and are therefore not to be considered limiting of its scope. The invention will be described and explained with additional specificity and detail through the use of the accompanying drawings in which:

FIG. 1 illustrates an example docketing system including an example docketing server;

FIG. 2A illustrates an example docketing server of the docketing system of FIG. 1;

FIG. 2B illustrates example data that may be stored as part of an intellectual asset record on the docketing server of FIG. 2A;

FIG. 3A is a block diagram depicting an example user interface object providing details on, and management of, related art references and citation status;

FIG. 3B is a block diagram depicting an example user interface object providing importation and copying of related art references;

FIG. 4 illustrates an example and non-exclusive set of citation status values;

FIG. 5 is a block diagram depicting an example user interface object representing a related art reference citation matrix;

FIG. 6 illustrates an example related art reference list document;

FIG. 7 illustrates an example method for related art citation generation;

FIG. 8 illustrates an example method for citation status maintenance;

FIG. 9 is a block diagram depicting an example user interface object providing details on tasks associated with an intellectual asset record;

FIG. 10 illustrates a block diagram illustrating an example computing device arranged for a method for related art citation management.

### DETAILED DESCRIPTION

Embodiments relate generally to intellectual asset docketing and management. More particularly, some example embodiments relate to related art citation management.

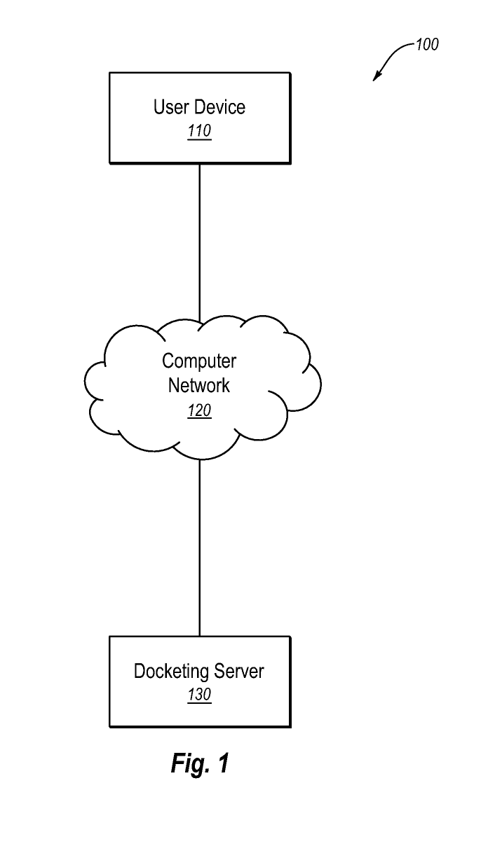

FIG. 1 illustrates an example docketing system 100. The docketing system 100 generally provides one or more docketing users (not shown) with a docketing service (not shown). The docketing system 100 may include a user device 110 communicatively coupled to a docketing server 130 via a computer network 120. The coupling between the docketing server 130 and the user device 110 may enable the docketing user to access at least some portion of a docketing service stored or otherwise available on the docketing server 130.

The docketing service may generally schedule legal matters and manage aspects of those legal matters. For example, an intellectual property docking service may support scheduling a disclosure submission and manage the related filing dates such as provisional application filing, non-provisional conversion dates, maintenance fees, and the like. The management and scheduling of these legal matters may be managed by a docketing server application (described below) which may include a set of templates, data, instructions, applications, computer programs, or some combination thereof. Alternatively or additionally, the docketing system 100 may provide a visible, accessible, user-interface to internal and/or external entities through which the legal matters are manually managed. Specifically, as described herein, the docketing service may include various docketing server applications that include one or more user interface objects, for instance, to enable the docketing user to manage related art citation.

The user device 110 in FIG. 1 may be a desktop computer, a laptop computer, a portable electronic device such as a cellular/mobile/smart phone, a tablet personal computer, a personal digital assistant, or any equivalent device. The user device 110 may include a docketing client software to access the docketing server 130, or the user device 110 may include a web browser to access the docketing server 130, where the docketing server 130 provides the docketing service as a web application. Alternatively, the user device 110 may communicate with the docketing server 130 through other means, such as a remote desktop connection.

Additionally, the user device 110 communicates with the docketing server 130 via the computer network 120. The computer network 120 relates to a collection of devices interconnected by communication channels that allows sharing of information among the interconnected devices. In this example embodiment, the computer network 120 may be or include any wired or wireless network technology such as optical fiber, electrical cables, Ethernet, radio waves, microwaves, an infrared transmission, wireless internet, communication satellites, cellular telephone signals, or an equivalent-networking signal that interfaces with devices to create a network. Specifically, in one embodiment, the user device 110 communicates with the docketing server 130 via the internet. In other embodiments, the user device 110 may be directly coupled with the docketing server 130 and/or may be integrated directly with, and be a part of, the docketing server 130.

In FIG. 1, one user device 110 is operably connected to communicate with the docketing server 130 via the computer network 120. However, in alternative embodiments a plurality of user devices 110 which may include various types of user devices 110 may simultaneously communicate with the docketing server 130. Additionally or alternatively, the docketing system 100 may include multiple docketing servers 130 which are operably connected to communicate information among the multiple docketing servers 130 and/or to communicate information among various user devices 110 operably connected to communicate with the docketing servers 130.

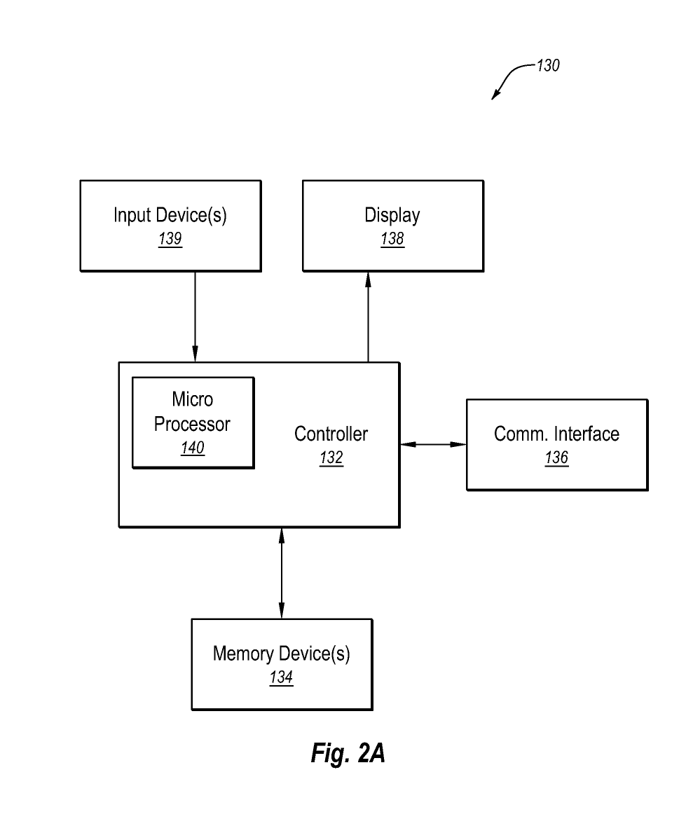

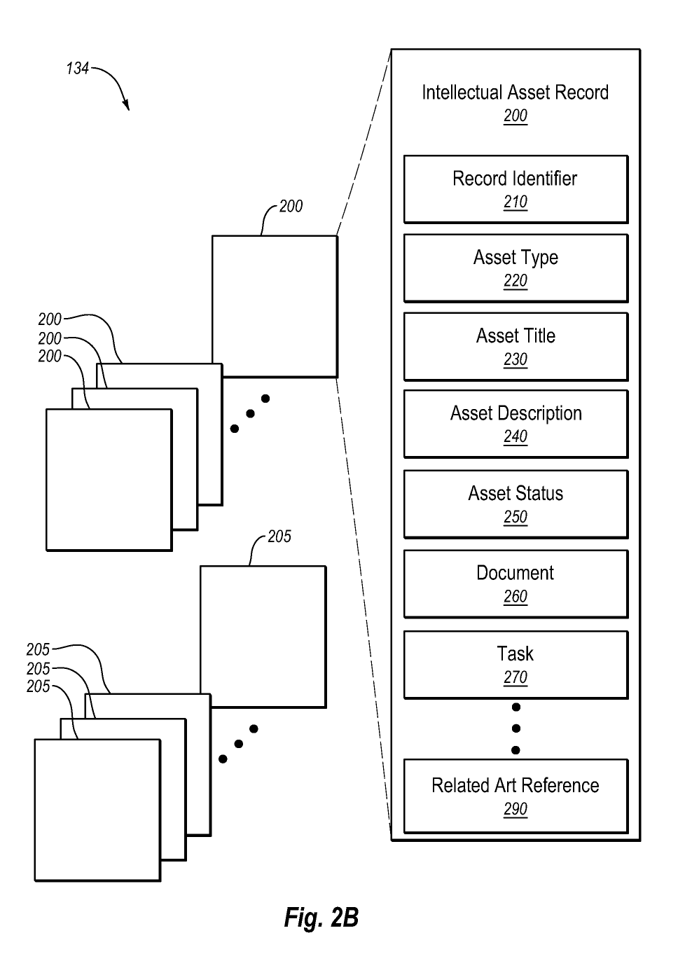

FIG. 2A illustrates additional details of the docketing server 130 of FIG. 1. As depicted in FIG. 2A, the docketing server 130 may include a controller 132 and a memory device 134. The controller 132 may include a microprocessor 140 which executes a docketing server application (not shown). The docketing server application may include templates, data, instructions, applications, or computer programs stored in a memory device 134. The docketing server application may vary as necessary to implement the docketing service.

In the embodiment illustrated in FIG. 2A, the controller 132 is operatively coupled to the memory device 134, which enables the controller 132 through the microprocessor 140 to access information stored on the memory device 134 such as the docketing server applications, an intellectual asset record (IA record) (described below), and/or a file (described below). The memory device 134 may provide data to the controller 132 in various forms, such as, but not limited to, database records, files, bitstreams, and bytestreams, and the memory device 134 may comprise volatile or non-volatile memory or storage.

As depicted in FIG. 2A, the docket server 130 can include a single controller 132, which can include one microprocessor 140 that executes a docketing server application, and a single memory device 134. However, in alternative embodiments, the docket server 130 may include one or more controllers 132, one or more microprocessors 140, which execute a plurality of docketing server applications, and one or more memory devices 134. The one or more memory devices 134 may be remotely located from each other and/or from the controller 132.

The docketing server 130 can include a communication interface 136. The communication interface 136 enables the docketing server 130 to communicate with a user device via a computer network. For example, with combined reference to FIGS. 2A and 1, the communication interface 136 may enable the user device 110 to communicate to the docketing server 130 via the computer network 120. Additionally, the communication interface 136 may enable the docketing server 130 to communicate with other docketing server applications either publically or privately available on the internet or through an interface between multiple docketing servers 130, which are operably connected via the computer network 120. Examples of the communication interface 136 include any receiver or transmitter capable of functioning with the computer network 120.

Referring back to FIG. 2A, the docketing server 130 may include a display 138 and one or more input devices 139. The docketing user (not shown) and/or a docketing server administrator (not shown) may directly interface and/or control the docketing server 130 through the display 138 and the input devices 139. Examples of the display 138 may include a thin film transistor liquid crystal display, liquid crystal display or an equivalent structure. Examples of the input devices 139 may include a QWERTY key pad, a ten key input pad, a mouse, a stylus, voice recognition software, an audio mixer, or may be integrated with the display 138 as in a touchscreen device using a surface acoustic wave, surface capacitance, projected capacitance, or an equivalent structure.

Turning next to FIG. 2B, additional details of the memory device 134 of FIG. 2A are disclosed. FIG. 2B illustrates data that may be stored in the memory device 134. Specifically, in some embodiments the data may include intellectual asset (IA) records 200 and/or files 205.

In alternative embodiments, the files 205 and the IA records 200 may be stored separately. For example, the files 205 may be stored on a first memory device and the IA records 200 may be stored on a second memory device. In this and other example embodiments, the first memory device may be located in a docketing server such as the docking server 130 of FIG. 2A and the second memory device may be located in a remote site. Alternatively, the files 205 and the IA records 200 may both be stored on a single memory device 134. Additionally or alternatively, other data may be stored in the memory device 134 including but not limited to docketing server applications, networking information, docketing user demographic or statistical information, docketing server administrator permissions, etc.

FIG. 2B further illustrates potential contents of the IA records 200. Generally, the IA records 200 include a set of related data organized into meaningful units that pertain to an intellectual asset such as a patent, a trademark, copyright, or the like. For example, the set of related data of the IA records 200 may be organized into the meaningful units including a record identifier 210, an asset type 220, an asset title 230, an asset description 240, an asset status 250, a document 260, a task 270, and a related art reference 290. Each of these meaningful units will be briefly discussed below.

With respect to the embodiment illustrated in FIG. 2B, the record identifier 210 is an identifier uniquely identifying the IA record 200 and can be used to reference the IA record 200. The asset type 220 may be used to distinguish between various types of intellectual assets, such as patents, trademarks, copyrights, trade secrets, etc. The asset title 230 may provide a human-readable name for the IA record 200, and the asset description 240 may provide a human-readable summary of the IA record 200. The asset status 250 may indicate the current status such as pending, abandoned, issued, etc. of the intellectual asset associated with the IA record 200.

Examples of the document 260 may include, but is not limited to, an archive, a record, a report, a paper, an article, a reference, a response, an action, a correspondence, a memorandum, an audio recording, a video recording, a photo, or a drawing. The document 260 is associated with the IA record 200 by being linked to the IA record 200. The link between the IA record 200 and the document 260 can be implemented through various techniques, which may include, storing in the IA record 200 a file path to the document 260, storing in the IA record 200 a database reference to the document 260, or the like. Additionally, the document 260 may be stored within the IA record 200 as illustrated in FIG. 2B or the document 260 may be stored separately from the IA record 200.

The embodiment depicted in FIG. 2B includes a single document 260 associated with the IA record 200. However, the document 260 may be a plurality of documents 260 that may include various examples listed above. Additionally or alternatively, the plurality of documents 260 may be associated with a single IA record 200, the plurality of documents 260 may be associated with multiple IA records 200, or some subset of the plurality of documents 260 may be associated with one or more IA records 200 within a docketing system. Once the file 205 is associated with the IA records 200, the file 205 may also referred to as the document 260.

Generally, the task 270 denotes an action for a specified docketing user to complete by a specified time. Some examples of the task 270 may include but are not limited to instructing outside counsel, attending meetings, etc. Like the document 260, the task 270 may be a plurality of tasks 270. That is, multiple tasks 270 may be, and commonly are, associated with the IA record 200.

The related art reference 290 provides metadata for a patent, a patent application, or non-patent literature that may be considered material to patentability. The metadata for the related art reference 290 may include a date, an author, a publication reference number, a country, a title, or some combination thereof. A plurality of related art references 290 may be associated with the IA record 200. Once a related art reference 290 is associated with the IA record 200, the related art reference 290 may be a document 260.

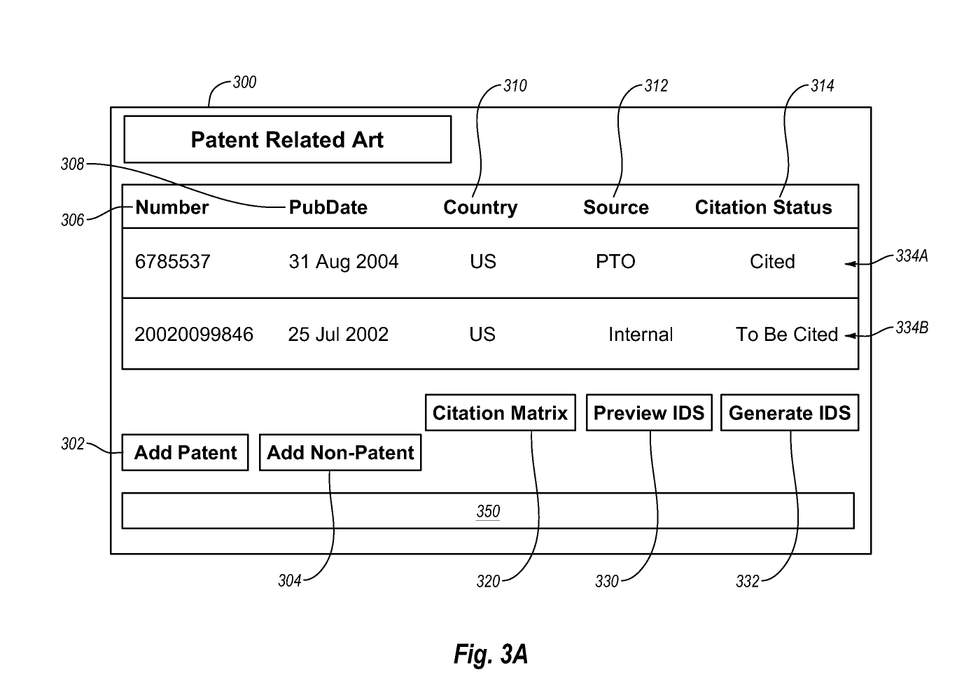

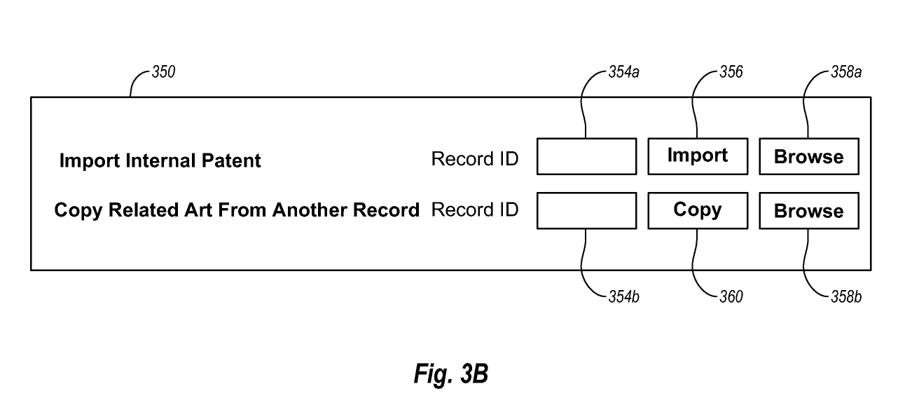

FIG. 3A is a block diagram depicting an example patent related art user interface object 300. The patent related art user interface object 300 may be presented and controlled by a docketing server such as docketing server 130 of FIGS. 1 and 2A which may provide details on, and management of, related art references and citation status. With combined reference to FIGS. 1, 2B, and 3A, by utilizing interface controls such as an “add patent” button 302 and an “add non-patent” button 304, a docketing user may bring up a new interface object (not shown) into which related art reference metadata may be entered for an IA record 200 and then stored by the docketing system 100.

Also provided via the patent related art user interface object 300 is a set of existing related art reference associated metadata 334A and 334B (collectively, 334) for a patent asset (e.g. a patent or a patent application) denoted by an IA record 200. That is, for each related art reference 290 (FIG. 2B), the associated metadata 334 is represented to provide details pertaining to the related art reference. The associated metadata 334 may include for example: a related art reference identifier (“number” in FIG. 3A) 306, a related art reference publication date (“PubDate” in FIG. 3A) 308, a related art reference source country (“Country” in FIG. 3A) 310, a related art reference source (“Source” in FIG. 3A) 312, and a related art reference citation status (“Citation Status” in FIG. 3A) 314.

Additional user interface controls are provided in the patent related art user interface object 300. For example, the additional user interface controls may include a citation matrix button 320, a preview IDS button 330, and a generate IDS button 332.

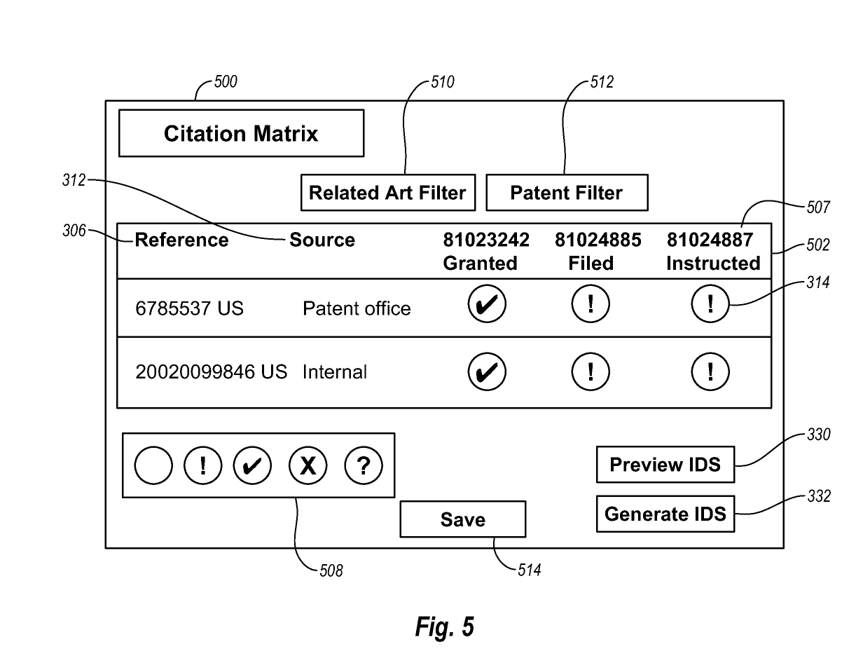

The docketing user may select the citation matrix button 320 to open a citation matrix user interface object for viewing and maintaining the citation status 314 of each of the related art references 290 for each member of a patent family. Some additional details of the citation matrix user interface object are discussed with reference to FIG. 5.

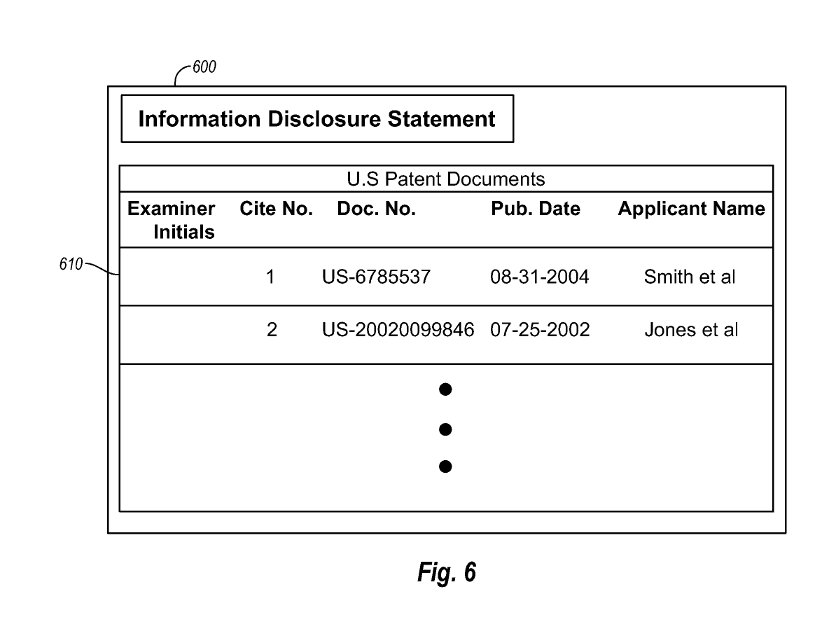

The docketing user may also select the preview IDS button 330 to prompt a docketing server 130 (FIGS. 1 and 2A) to display a preview of a related art reference list document. A non-limiting example of the related art reference list document 600 is shown in FIG. 6, where the related art reference list document 600 is an information disclosure statement (IDS) as utilized by the USPTO. To generate the related art reference list document 600 to provide to a patent office such as the USPTO, the docketing user may select the generate IDS button 340 on the patent related art user interface object 300 of FIG. 3. As will be described in further detail below, generation of the related art reference list document also modifies the citation status 314 for each listed related art reference 290 (FIG. 2B).

Additionally, the patent related art user interface object 300 may include a set of user interface controls 350 as illustrated in FIG. 3B. The docketing user may add the related art reference 290 to the IA record 200 in the patent docketing system 100 by linking to a second IA record in the patent docketing system 100, the second record being a patent record, by entering an identifier (ID) of the second IA record in a record ID text field 354a and selecting an import button 356.

Alternatively, the docketing user may select a browse button 358a to choose the identifier of the second IA record from a list of records in the patent docketing system 100. The docketing user may also add the related art reference 290 to the IA record 200 in the patent docketing system 100 by copying the related art reference 290 from a third IA record, the third IA record being one of a patent record and an invention record, in the patent docketing system 100 by entering an ID of the third IA record in a record ID text field 354b and selecting a copy button 360. Alternatively, the docketing user may select a browse button 358b to choose the ID of the third IA record from a list of records in the patent docketing system 100. The copy functionality may alternatively be provided in the reverse—that is, one or more related art references 290 of the IA record 200 may instead be copied to the third IA record.

While reference has been made to patent related art in FIGS. 3A and 3B, corresponding functionality and user interface objects and controls may also be provided for an invention record to add the related art reference 290.

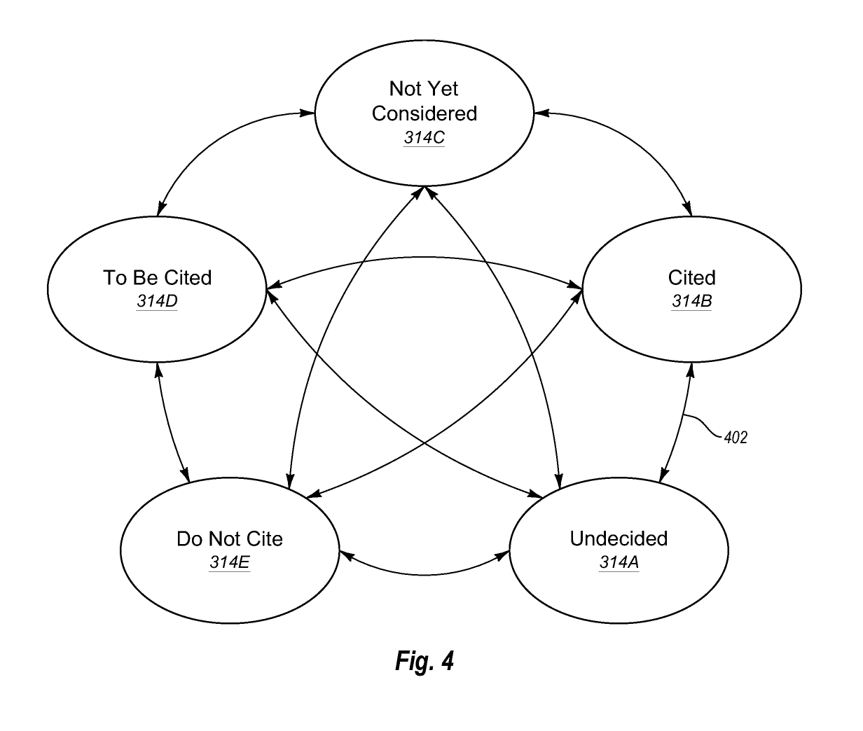

Referring now to FIG. 4, various example possible citation status values 314A-314E for the citation status 314 of FIG. 3A are represented, with possibility of a transition 402 (all arrows) between each citation status value 314A-314E. The non-exclusive values 314A-314E being “not yet considered” 314C, “to be cited” 314D, “cited” 314B, “do not cite” 314E, and “undecided” 314A. Each of the citation status 314A-314E values as presented herein provides a meaning for the citation status 314 and can be represented within the related art reference 290 in any form, such as textually, numerically, graphically, etc., as long as each of the citation status values 314A-314E represents the distinct meaning for the citation status 314. For example, the citation status value “not yet considered” 314C denotes that the corresponding related art reference 290 has not yet been considered for citation for the patent asset designated by the IA record 200. The citation status value “to be cited” 314D indicates that the corresponding related art reference 290 should be cited for the patent asset designated by the IA record 200. The citation status value “cited” 314B denotes that the corresponding related art reference 290 has been cited for the patent asset designated by the IA record 200. The citation status value “do not cite” 314E implies that the corresponding related art reference 290 should not be cited for the patent asset designated by the IA record 200. The citation status value “undecided” 314A denotes that the corresponding related art reference 290 has been considered for citation for the patent asset designated by the IA record 200, but no citation decision has yet been reached.

Not all citation status values 314A-314E are required, however, in some embodiments the citation status values “to be cited” and “cited” are utilized, as will be described in more detail with reference to FIG. 5.

FIG. 5 is a block diagram depicting an example citation matrix user interface object 500. The citation matrix user interface object 500 may be presented and controlled by the docketing server 130 according to some embodiments. The citation matrix user interface object 500 presents a citation matrix 502 for a first patent document. The first patent document may be a patent application or an issued patent, in a patent family, for example. The citation matrix 502 may be presented as a table with at least one row and at least one column. The controller 132 provides access to the citation matrix 502 from the IA record 200 that may be a patent record or an invention record, for example. The table is populated with at least one patent document identifier 507 and at least one related art reference identifier 306. The patent document identifier 507 includes an identifier of the first patent document. The patent document identifier 507 corresponding to the first patent document may be included in the citation matrix 502, and the patent document identifier 507 for each other patent family member patent document is also presented. For each combination of a patent document identifier 507 and a related art reference identifier 306, the citation status 314 is displayed. Each combination is denoted as an intersection of a row and a column.

The citation status 314 may be represented in various forms, such as textually, graphically, numerically, etc. In FIG. 5, the citation status for each combination of the related art reference identifier 306 and the patent reference identifier 507 is presented graphically. For example, possible citation statuses are depicted in box 508. In the box 508 an empty circle represents a “not yet considered” value for the citation status 314; a circle with an exclamation point represents “to be cited”; a circle with a check mark indicates a “cited” value; a circle with an “X” represents a value of “do not cite”; and a circle with a question mark denotes a value for the citation status 314 of “undecided”. Other designations possible citation status values are possible, and the graphical representations in the box 508 are provided for illustration only.

As in the patent related art user interface object 300, the citation matrix user interface object 500 presents related art reference metadata, including, for example, the related art reference identifier 306 and the related art reference source 312. The related art reference identifier 306 may include a country identifier and a patent document number, such as an issued patent number or a patent application publication number.

For example, in FIG. 5, the identified related art reference identifier 306 includes the country identifier “US”, representing the United States, along with the issued U.S. Pat. No. 6,785,537. The related art reference source 312 includes an indication of a source of the related art reference 290, for example “internal”, “patent office”, “third party”, etc. An internal source may be, for example, an inventor who provides the related art reference 290 through an invention disclosure. When a patent office cites a reference during patent examination, the related art reference source 312 may therefore indicate “patent office” An example of a “third party” source is a party other than the applicant or patent office submitting a reference purported to be of relevance in a patent re-examination or opposition request.

The patent family may include for example, the first patent document, other patent documents filed in other jurisdictions than is the first patent document, and other patent documents originating from a same invention and/or an original priority patent document. For example, a first non-provisional US patent application, a US continuation patent application claiming priority to the first non-provisional US patent application, a Patent Cooperation Treaty (PCT) application claiming priority to the first non-provisional US patent application, and all national phase patent applications originating from the PCT application are all members of the same patent family. Each of the patent family members is identified in the citation matrix user interface object 500 by the patent document identifier 507. By providing the citation matrix 314 for all patent family members, multiple docketing users, each of whom may be managing a different one of the patent family members, can better manage related art citation management by having complete visibility into citation across the family. In this and other embodiments, each of the patent document identifier 507 is provided in a column in the citation matrix 502, and each of the related art reference identifier 306 is provided in a row in the citation matrix 502, though the row/column arrangement may be reversed and still provide the citation status 314 for each combination thereof. The patent document identifier 507 may include any type of appropriate identifier, including, but not limited to, the record identifier 210, an issued patent identifier, a patent application publication identifier, a patent application serial number, or an internal patent reference identifier. In the example provided in FIG. 5, the patent document identifier 507 is presented as the record identifier 210 for each respective IA record 200, each of which designates a patent document. For each patent document identifier 507, the patent document status 250 may be provided, wherein the patent document status 250 may be, for example, instructed, filed, published, granted, issued, etc.

The citation matrix user interface object 500 may also include a related art filter button 510 and a patent filter button 512. The docketing user may select the related art filter button 510 to have the docketing server 130 present a list of related art reference filtration options, each of which includes a checkbox, for which types of related art references to include or not include in the citation matrix 502. For example, the list of related art reference filtration type options may include US patents, US patent applications, non-US patent documents, non-patent literature documents, etc. Therefore, for example, selection of the US patent option may cause inclusion in the citation matrix 502 of related art references 290 that are US patents. De-selection of the non-patent literature documents option may hide within the citation matrix 502 any related art reference 290 that is non-patent literature. Selection of the patent filter button 512 causes the docketing server 132 present a list of patent record filtration options, each of which includes a checkbox, for which members of the patent family to include or not include in the citation matrix 502. For example, the list of patent record filtration options may comprise a list of all patent family members, and may additionally comprise US patent documents or other national patent documents. So, selection of only the patent document identifier 507 value of 81024887 in the example provided in FIG. 5 may cause inclusion in the citation matrix 502 of only the IA record 200 identified by the record identifier 200 having a value of 81024887. Other members of the patent family may, in that case, be hidden in the citation matrix 502.

The docketing user may modify the citation status 314 by first selecting a citation status value from a citation status value selection area 508 and then selecting the intersection of the related art reference identifier 306 and the patent document identifier 507. Any modifications made by the docketing user can then be saved in the IA record 200 by the docketing server 130 when the docketing user selects a save button 514.

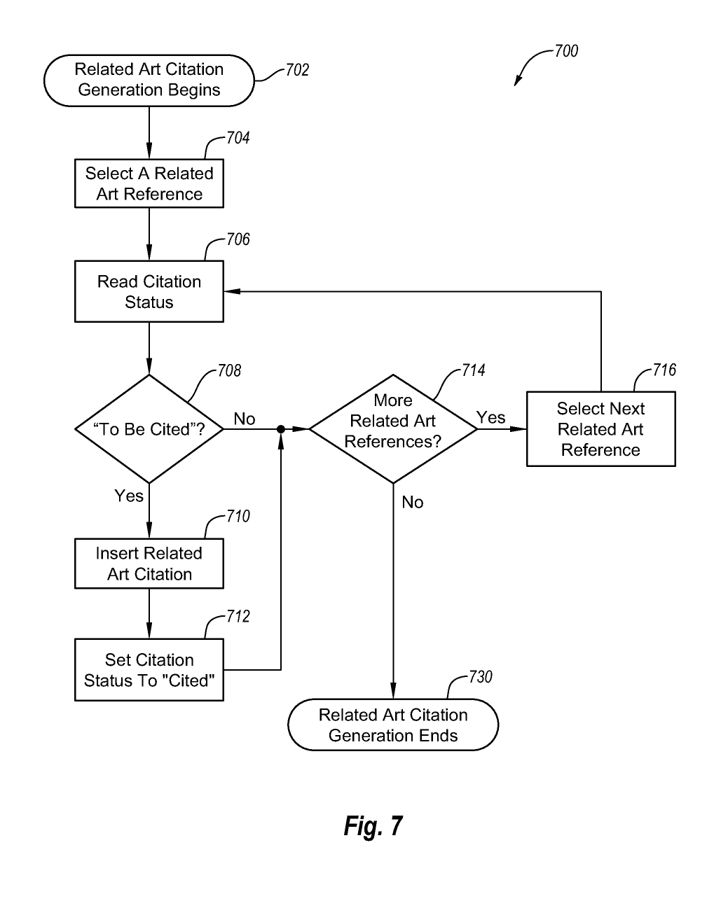

FIG. 7 is a flow diagram depicting an example method 700 for related art citation generation. The method 700 may be performed by an electronic device, such as the docketing server 130 of FIG. 1. The method 700 may be manually initiated by the docketing user, or may be automatically initiated according to a predefined schedule stored on the one or more of memory devices 134, with the pre-defined schedule read by the controller 132. With combined reference to FIGS. 5 and 7, to manually trigger generation of the related art reference list document 600 (FIG. 6) that may be provided to a patent office such as the USPTO, the docketing user may select one patent document identifier 507 and then select the generate IDS button 340. One skilled in the art will appreciate that, for this method and any other method included herein, the functions performed may be implemented in differing order. Furthermore, the outlined steps and operations are only provided as examples, and some of the steps and operations may be optional, combined into fewer steps and operations, or expanded into additional steps and operations without detracting from the disclosed embodiments.

Referring back to FIG. 7, at 702 the method 700 begins. At 704, the controller 132 of the docketing server 130 selects a first related art reference 290. At 706, the controller 132 reads the citation status 314 of the first related art reference 290 for the selected patent document identifier 507.

At 708, the controller determines whether the citation status 314 has a value of “to be cited”. If the citation status is “to be cited”, method 700 proceeds to 710. If however, the citation status is not “to be cited”, the method 700 proceeds to 714.

At 710, the controller 132 inserts into the related art reference list document 600 a related art citation 610. The related art citation 610 (FIG. 6) comprising metadata for the related art reference 290.

At 712, after inserting the related art citation 610 into the related art reference list document 600, the controller 132 modifies the citation status 314 to have a value of “cited”. In some embodiments, the controller 132 may additionally lock the citation status 314 to maintain the “cited” value, which may disallow further modification.

At 714, the controller 132 determines whether there are more related art references 290. If the controller 132 determines there are additionally related art references 290, the method 700 proceeds to 716. If however, the controller determines there are not any additional related art references 200, the method 700 proceeds to 730.

At 716, the controller selects the next related art reference 290. The method 700 then proceeds to 706 through 712 as described above. That is, as long as there are more related art references 290, the controller 132 selects each—next related art reference 290, proceeds to 716, and performs 706 through 712. By doing so, method 700 addresses the citation status of all related art references 290. Additionally, when the citation status 314 for the selected related art reference 290 does not have a value of “to be cited” at 708, the controller 132 does not perform steps 710 and 712, and proceeds to check for more related art references 290 at 714. When there are no more related art references, the method 700 proceeds to 730. The method 700 ends at 730.

Upon completion of all related art citation insertion, the controller 132 completes generation of the related reference list document 600. Refreshing the citation matrix 502 reflects the citation status 314 value modifications made as a result of generation of the related art reference list document 600.

The preview IDS button 330 from the patent related art user interface object 300 may also be included within the citation matrix user interface object 500, selection of which prompts the docketing server 132 provide a preview of the related art reference list document 600 (FIG. 6) for a selected patent document identifier 507, where the related art reference list document 600 in this example is shown as an information disclosure statement (IDS) as utilized by the USPTO. Just as for generating the related art reference list document 600, the related art citation 610 is included as a result of the corresponding citation status 314 having a value of “to be cited”. However, previewing the related art reference list document 600 preserves the citation status 314 value—that is, the docketing server 130 maintains the citation status 314 as “to be cited”. The preview IDS functionality allows the docketing user to preview how the related art reference list document 600 may look if generated, without affecting the citation status 314 of any related reference 290.

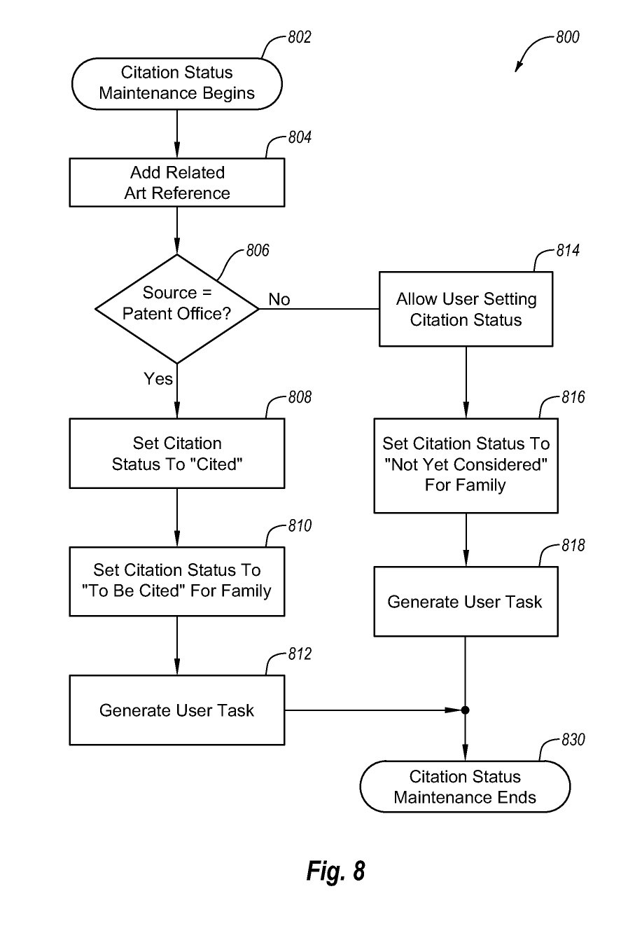

FIG. 8 is a flow diagram depicting an example method 800 for citation status maintenance. The citation status maintenance process 800 may be performed by an electronic device, such as the docketing server 130 of FIG. 1. At 802, the citation status maintenance process 800 begins.

At 804 the controller 132 of the docketing server 130 responds to the docketing user adding the related art reference 290 to a first IA record 200. In some embodiments, the first IA record 200 is either an invention record or a patent record. As described with reference to FIGS. 3A and 3B, the docketing user may add the related art reference 290 to the first IA record 200 in the patent docketing system 100 by copying the related art reference 290 from a second IA record 200 in the patent docketing system 100. The second IA record 200 may be a patent record or an invention record.

Also as described with reference to FIGS. 3A and 3B, the docketing user may add the related art reference 290 to the first IA record 200 in the patent docketing system 100 by linking to a third IA record 200 in the patent docketing system 100. The third IA record 200 may a patent record. The docketing user may also add the related art reference 290 to the first IA record 200 in the patent docketing system 100 by entering data into the patent docketing system 100 through, for example, selecting the add patent button 302 or the add non-patent button 304 of FIG. 3A and entering the metadata for the related art reference 290 through a subsequent user interface object presented by the controller 132.

When the first IA record 200 is an invention record, the controller 132 defaults the related art reference source 312 to “internal”. If however, the first IA record 200 is a patent record, then if at 806 the controller 132 determines that the related art reference source 312 is “patent office”, then the controller 132 sets citation status 314 to have a value of “cited” at 808. The controller 132 then also sets the citation status 314 for each IA record 200 of patent family members to “to be cited” at 810.

At 812 the controller 132 generates the docket task 270 indicating to a user of the patent docketing system 100 a need to review the related art reference 290 for determining and setting a new status value for the citation status 314. The citation status maintenance process 800 ends at 830.

If at 806 the controller 132 determines that the related art reference source 312 is not “patent office”, then at 814 the controller 132 allows the docketing user to supply a value for the citation status 314, and at 816 the controller 132 also sets the citation status 314 for each IA record 200 of patent family members to “not yet considered” at 816.

At 818 the controller 132 generates the docket task 270 indicating to a user of the patent docketing system 100 a need to review the related art reference 290 for determining and setting a new status value for the citation status 314.

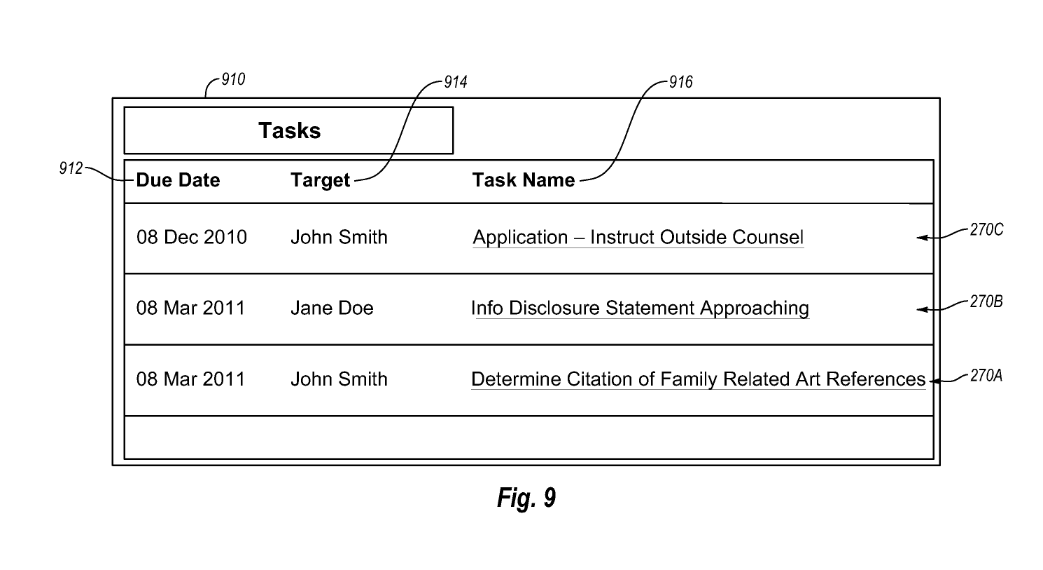

FIG. 9 is a block diagram depicting an example task list user interface object 910 providing details on one or more tasks 270A/270B/270C associated with the IA record 200. The task list user interface object 910 renders task highlights such as a due date value 912, a target value 914, and a task name value 916. In the example task 270A provided in FIG. 9, the due date value 912A is “Mar. 8, 2011” with the target value 914A of “John Smith” for the task name value 916A of “Determine Citation of Family Related Art References”. This may mean that John Smith needs to review patent family related art references in the citation matrix 502 and determine which related art references to cite by Mar. 8, 2011 for a patent asset associated with the IA record 200. The action that John Smith needs to take in this example may be described by a corresponding task 270 in a docketing schedule, and the task 270A may be created by the docketing user, or automatically by the docketing server 130 as described in 812 and in 818 in the citation maintenance process 800 in FIG. 8.

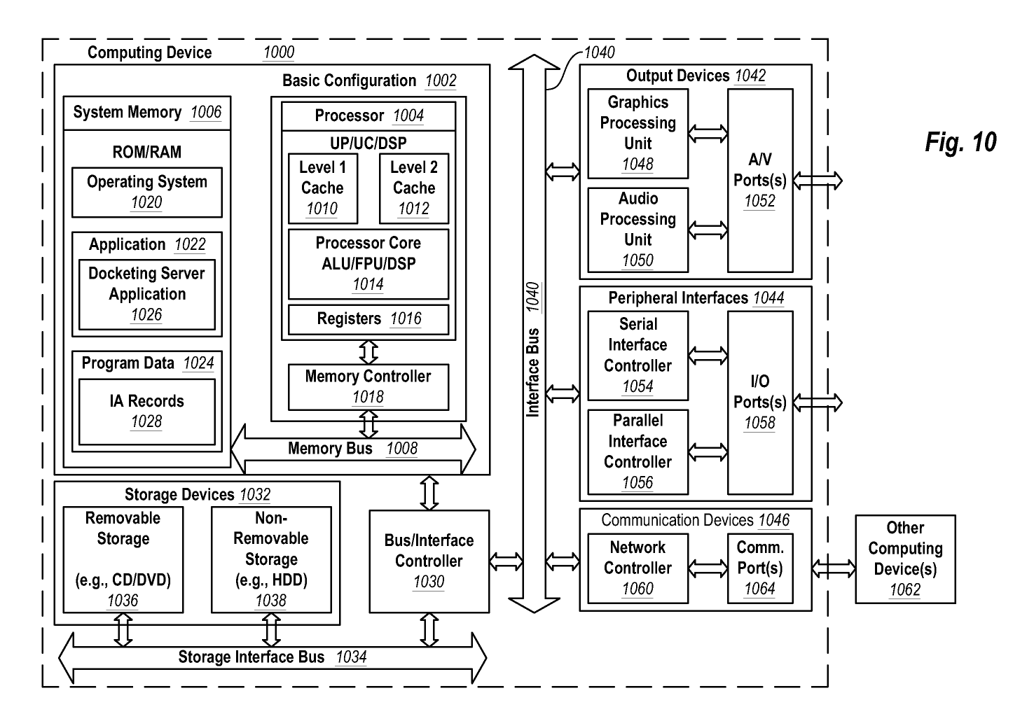

FIG. 10 is a block diagram illustrating an example computing device 1000 that is arranged for a method for related art citations management in accordance with the present disclosure. In a basic configuration 1002, computing device 1000 typically includes one or more processors 1004 and a system memory 1006. A memory bus 1008 may be used for communicating between processor 1004 and system memory 1006.

Depending on the desired configuration, processor 1004 may be of any type including but not limited to a microprocessor (μP), a microcontroller (μC), a digital signal processor (DSP), or any combination thereof. Processor 1004 may include one or more levels of caching, such as a level one cache 1010 and a level two cache 1012, a processor core 1014, and registers 1016. An example processor core 1014 may include an arithmetic logic unit (ALU), a floating point unit (FPU), a digital signal processing core (DSP Core), or any combination thereof. An example memory controller 1018 may also be used with processor 1004, or in some implementations, memory controller 1018 may be an internal part of processor 1004.

Depending on the desired configuration, system memory 1006 may be of any type including but not limited to volatile memory (such as RAM), non-volatile memory (such as ROM, flash memory, etc.) or any combination thereof. System memory 1006 may include an operating system 1020, one or more applications 1022, and program data 1024. Application 1022 may include a docketing server application 1026 that is arranged to relate patent related art to IA records 200. Program data 1024 may include IA records 1028 or some contents thereof that may be used for association of patent related art to IA records 200 as is described herein. In some embodiments, application 1022 may be arranged to operate with program data 1024 on operating system 1020 such that related art citation generation and or citation status maintenance may be performed on the computing device 1000. This described basic configuration 1002 is illustrated in FIG. 10 by those components within the inner dashed line.

Computing device 1000 may have additional features or functionality, and additional interfaces to facilitate communications between basic configuration 1002 and any required devices and interfaces. For example, a bus/interface controller 1030 may be used to facilitate communications between basic configuration 1002 and one or more data storage devices 1032 via a storage interface bus 1034. Data storage devices 1032 may be removable storage devices 1036, non-removable storage devices 1038, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 1006, removable storage devices 1036, and non-removable storage devices 1038 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 1000. Any such computer storage media may be part of computing device 1000.

Computing device 1000 may also include an interface bus 1040 for facilitating communication from various interface devices (e.g., output devices 1042, peripheral interfaces 1044, and communication devices 1046) to basic configuration 1002 via bus/interface controller 1030. Example output devices 1042 include a graphics processing unit 1048 and an audio processing unit 1050, which may be configured to communicate to various external devices such as a display or speakers via one or more A/V ports 1052. Example peripheral interfaces 1044 include a serial interface controller 1054 or a parallel interface controller 1056, which may be configured to communicate with external devices such as input devices (e.g., keyboard, mouse, pen, voice input device, touch input device, etc.) or other peripheral devices (e.g., printer, scanner, etc.) via one or more I/O ports 1058. An example communication device 1046 includes a network controller 1060, which may be arranged to facilitate communications with one or more other computing devices 1062 over a network communication link via one or more communication ports 1064.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 1000 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 1000 may also be implemented as a personal computer including both laptop computer and non-laptop computer configurations.

The previously described versions of the present invention have many advantages, including providing a related art citation management solution which can be utilized to track and maintain proper related art reference citations as required with various patent offices through a citation matrix, automated citation status management, central coordination, and related art reference list document generation and preview. The present invention does not require that all the advantageous features and all the advantages need to be incorporated into every embodiment.

The present invention may be carried out in other specific ways than those herein set forth without departing from the scope of the invention. For example, user interface controls are described herein, such as “buttons”, but as will be appreciated by one having skill in the art, the user interface controls are presented as examples only, as such controls as buttons may alternatively be implemented and presented as links or dropdowns. The present embodiments are, therefore, to be considered in all respects as illustrative and not restrictive, and all changes coming within the meaning and equivalency range of the appended claims are intended to be embraced therein.

What is claimed is:

1. A method of automating related art citation generation, the method comprising:
reading a citation status of a related art reference for a patent document;
generating a related art reference list document; and
in response to the citation status of the related art reference having a first citation status value, inserting into the related art reference list document a related art citation including metadata for the related art reference.

2. The method of claim 1, further comprising modifying the citation status to have a second citation status value after inserting the related art citation into the related art reference list document.

3. The method of claim 2, further comprising:
prior to generating the related art reference list document, generating a preview of the related art reference list document, wherein generating the preview preserves the first citation status value of the citation status.

4. The method of claim 2, wherein the second citation status value denotes citation of the related art reference.

5. The method of claim 1, wherein the first citation status value denotes a need to cite the related art reference.

6. The method of claim 1, further comprising detecting a user input, the user input triggering generation of the related art reference list document.

7. The method of claim 1, wherein the related art reference is one of a patent, a patent application, and non-patent literature.

8. The method of claim 1, wherein the metadata comprises at least one of a date, an author, a publication reference number, and a title.

9. A computer storage medium having computer executable instructions stored thereon for performing the method of claim 1.

10. A method of maintaining a citation status of a related art reference for a first patent document in a patent family, the method comprising:
adding the related art reference to a first record in a patent docketing system; and
setting the citation status to a first citation status value in response to adding the related art reference to the first record, wherein the first record pertains to one of the first patent document and a second patent document in the patent family,
wherein at least one of the preceding actions is performed on at least one electronic hardware component.

11. The method of claim 10, further comprising determining a source of the related art reference.

12. The method of claim 11, wherein the first record is a patent record, the first record pertains to the first patent document, and the source of the related art reference is a patent office, and wherein setting the citation status to a first citation status value comprises setting the citation status to denote citation of the related art reference.

13. The method of claim 12, wherein the first record is a patent record, the first record pertains to the second patent document, and the source of the related art reference is a patent office, and wherein setting the citation status to a first citation status value comprises setting the citation status to denote a need to cite the related art reference.

14. The method of claim 13, further comprising generating a docket task, the docket task indicating to a user of the patent docketing system a need to review the related art reference for determining and setting a second status value for the citation status.

15. The method of claim 10, wherein adding the related art reference to the first record in the patent docketing system comprises copying the related art reference from a second record in the patent docketing system, the second record being one of a patent record and an invention record.

16. The method of claim 10, wherein adding the related art reference to the first record in the patent docketing system comprises linking to a second record in the patent docketing system, the second record being a patent record.

17. The method of claim 10, wherein adding the related art reference to the first record in the patent docketing system comprises recording the related art reference according to data entered by a user of the patent docketing system.

18. A docketing server comprising:
at least one memory device for storing one or more intellectual asset records;
a controller operatively connected to the at least one memory device, wherein the controller:
presents a citation matrix for a first patent document in a patent family, wherein the citation matrix is presented as a table, the table comprising at least one row and at least one column;
populates the table with at least one patent document identifier and at least one related art reference identifier, wherein the at least one patent document identifier comprises an identifier of the first patent document; and
displays a citation status for each combination of a patent document identifier of the at least one patent document identifier and a related art reference identifier of the at least one related art reference identifier, wherein the combination is denoted as an intersection of a row of the at least one row and a column of the at least one column.

19. The docketing server of claim 18, wherein the least one patent document identifier further comprises an identifier of a second patent document, wherein the second patent document is also a member of the patent family.

20. The docketing server of claim 18, wherein the controller further provides to a user of the docketing server an ability to input the citation status.

21. The docketing server of claim 20, wherein the controller further modifies the citation status to one of “not yet considered”, “to be cited”, “cited”, “do not cite”, and “undecided” according to the user input.

22. The docketing server of claim 18, wherein the controller further hides at least one of the at least one patent document identifier and the at least one related art reference identifier based on a filter setting.

23. The docketing server of claim 18, wherein the controller further locks the citation status to maintain a status value of “cited” in response to a related art reference citation for a patent document.

24. The docketing server of claim 18, wherein the controller further provides access to the citation matrix from a record, wherein the record is one of a patent record and an invention record.

25. The docketing server of claim 24, wherein the controller further:
generates a related art reference list document; and
inserts into the related art reference list document a related art citation in response to the citation status having a value of “to be cited”, wherein the related art citation comprises metadata for a related art reference.

26. The docketing server of claim 18, wherein the patent document identifier is one of a patent document publication number, an internal reference number, and an intellectual asset record identifier.
